(19) United States
(12) Patent Application Publication
(10) Pub. No.: US 2025/0389875 A1
(43) Pub. Date: Dec. 25, 2025

(54) COLORIZED RETROREFLECTIVE MATERIAL AND METHOD OF MANUFACTURE

(71) Applicant: Tze Ching WONG, Tsuen Wan (HK)

(72) Inventor: Tze Ching WONG, Tsuen Wan (HK)

(21) Appl. No.: 18/747,775

(22) Filed: Jun. 19, 2024

(51) Int. Cl. G02B 5/128

(52) U.S. Cl. CPC G02B 5/128

(57) ABSTRACT

A colorized retroreflective material includes a retroreflective material defining a retroreflective material surface; a silane-free light transmitting colorizing layer disposed on the retroreflective material surface, the silane-free light transmitting colorizing layer defining a colorizing surface; and a transparent layer disposed on the colorizing surface; where the colorized retroreflective material provides a reflectivity of more than 150 cd/lux/m².

### FIELD OF THE INVENTION

The present invention relates to colorized retroreflective materials which are durable and highly reflective. The present invention further relates to methods of manufacturing the colorized retroreflective materials.

### BACKGROUND

A retroreflector is a device or surface that reflects light back to its source with a minimum amount of scattering. Retroreflective materials of various kinds have been used for many years. Particular applications include various kinds of personal protective equipment including clothing. In order to improve nighttime visibility and safety of pedestrians, cyclists, roadway workers, joggers, and others who might otherwise be difficult to identify, these individuals can wear clothing having reflective materials which are designed to reflect light back in the direction of incidence. For example, incident light from vehicle headlights can be reflected back to the vehicle, making the presence of the individual wearing the reflective material more visible to the driver of the vehicle. The same easy visualization can be utilized relative to light coming from spotlights, searchlights, and even flashlights.

Certain conventional retroreflective technology for textile and garments, such as sportswear and outerwear, includes an array of transparent retroreflective elements partially embedded with a reflective undercoating in a binder layer which, in turn, binds the embedded beads to a layer of material which can be fixed to an article of clothing. The retroreflective elements can be spherical glass micro-beads. Producing such materials can be done by one of several techniques.

A first conventional technique involves heat transfer films in which glass beads are hemi-spherically vapor-coated with a retroreflective material (e.g., silver, aluminum, or a clear mirror coat used on white/clear reflective film). These beads are then deposited on a bead-bonding adhesive such that the reflective-coated side is in contact with the bead-bonding adhesive and the non-coated side is exposed. The bead bond adhesive is then coated with a second adhesive which provides adhesion to a garment. This adhesive is generally a hot-melt adhesive designed for heat lamination to a fabric. Alternatively, the second adhesive may be a pressure-sensitive adhesive.

A second conventional technique involves retroreflective fabrics. These fabrics can be similar in construction to heat transfer films, however, in this case, a fabric layer is applied and bonded to the second adhesive directly after coating and before application to a garment. This produces a reflective fabric construction that can be stored and later sewn onto garments.

A conventional technique for producing colorized retroreflective materials includes providing a colorized layer on an underside of partially embedded retroreflective elements which are overlaid by a retroreflective layer. Many, or even most, of the colorized reflective materials incorporated into sportswear and/or outerwear are usually silver in color, however.

Vinyl-based materials that are not made with glass-bead retroreflective technology have also been used conventionally. Materials of this type can be somewhat uncomfortable for the wearer and are, accordingly, less desirable for use on clothing.

Still further, some of the available colorized layers (i.e., the available inks) which are conventionally coated to retroreflective materials include silane in their compositions. Silane is highly flammable and these compositions therefore present the same flammability risk.

There remains a need in the art for an improved colorized retroreflective materials. There is a need for colorized retroreflective materials that can be incorporated into sportswear and/or outerwear clothing and other items, where the colorized retroreflective materials maintain a high level of reflectivity and appearance throughout the useful life of the item, which would include numerous laundering cycles.

### SUMMARY

An object of the present invention is to provide a colorized retroreflective material that overcomes or mitigates one or more disadvantages of conventional colorized retroreflective materials.

Another object of the present invention is to provide a colorized retroreflective material that provides a useful alternative to conventional colorized retroreflective materials.

In accordance with one aspect of the project invention, a colorized retroreflective material includes a retroreflective material defining a retroreflective material surface; a silane-free light transmitting colorizing layer disposed on the retroreflective material surface, the silane-free light transmitting colorizing layer defining a colorizing surface; and a transparent layer disposed on the colorizing surface; wherein the colorized retroreflective material provides a reflectivity of more than 150 cd/lux/m².

In accordance with one aspect of the project invention, a method for colorizing a retroreflective material includes providing a retroreflective material suitable for colorizing, the retroreflective material defining a retroreflective material surface; coating the retroreflective material surface with a silane-free light transmitting colorizing composition; drying the silane-free light transmitting colorizing composition for a predetermined amount of time, such that the silane-free light transmitting colorizing composition thereby becomes a silane-free light transmitting colorizing layer, the silane-free light transmitting colorizing layer defining a colorizing surface; and applying a transparent layer on the colorizing surface to thereby provide a colorized retroreflective material; wherein the colorized retroreflective material provides a reflectivity of more than 150 cd/lux/m².

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Reference is made to the accompanying drawings wherein:

FIG. 1 is a schematic of a side elevational view of a colorized retroreflective material in accordance with one or more embodiments of the present invention;

FIG. 2 is a further schematic of a side elevational view of a colorized retroreflective material in accordance with one or more embodiments of the present invention, which includes a 20× magnified photo;

FIG. 3 is 20× magnified photos of colorized retroreflective materials made in accordance with one or more embodiments of the present invention; and

FIG. 4 is 20× magnified photos of colorized retroreflective materials made in accordance with the prior art (which FIG. 4 is therefore labeled with PRIOR ART) for comparison with the photos of FIG. 3.

### DETAILED DESCRIPTION

One or more embodiments of the present invention relate to an improved colorized retroreflective material. More particularly, one or more embodiments relate to colorized, durable, highly reflective tapes for application to fabrics/garments, such as sportswear and/or outerwear. Advantageously, the colorized retroreflective materials retain both color and high reflectivity through many laundering cycles. In addition to providing the high level of reflectivity, the colorized retroreflective materials are aesthetically pleasing and also do not interfere with the comfort of the garments for the wearer. Moreover, the colorized reflective material can be of a color which matches the color of the sportswear and/or outerwear. One or more embodiments of the present invention further relate to methods of manufacturing the colorized retroreflective material.

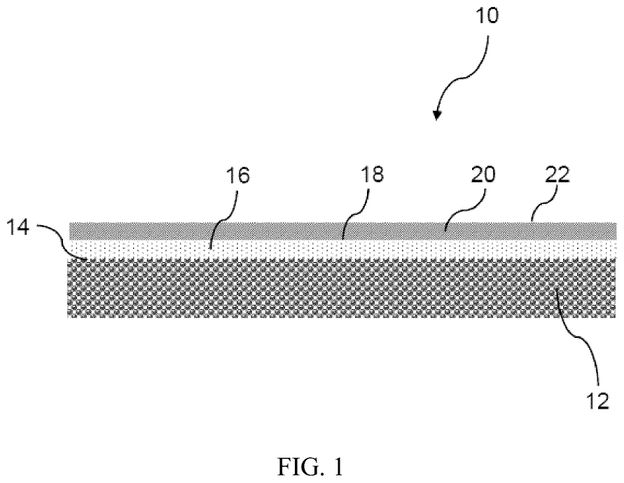

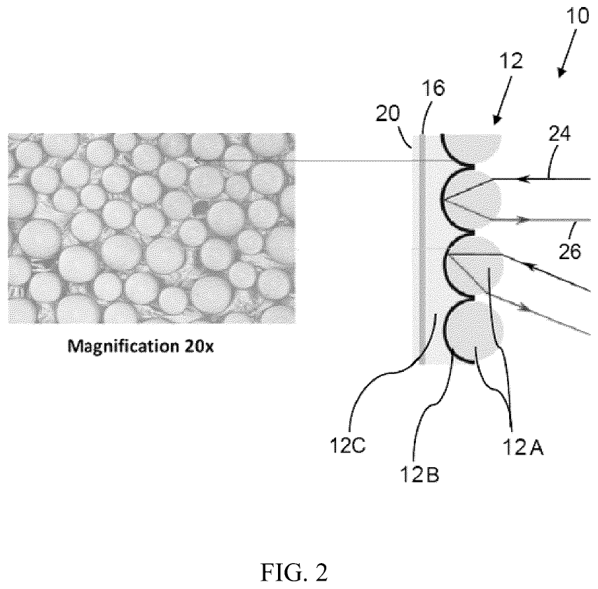

With reference to the Figures, particularly FIG. 1 and FIG. 2, a colorized retroreflective material is generally labeled with the numeral 10. Colorized retroreflective material, which may be referred to as colorized retroreflective tape 10 or tape 10, includes a retroreflective material 12 which defines a retroreflective material surface 14 (FIG. 1). Retroreflective material 12, which may be referred to as retroreflective tape 12 or tape 12, is capable of being colorized which may be referred to as being suitable for colorizing.

Colorized retroreflective material 10 further includes a silane-free light transmitting colorizing layer 16 disposed on retroreflective material surface 14. Silane-free light transmitting colorizing layer 16 derives from an ink composition, which ink composition can be applied in any suitable manner, such by coating retroreflective material surface 14 with the ink composition to thereby form a coating of silane-free light transmitting colorizing layer 16. Silane-free light transmitting colorizing layer 16, which may be referred to as ink 16, defines a colorizing surface 18 (FIG. 1).

Colorized retroreflective material 10 further includes a transparent liner 20 disposed on colorizing surface 18. Transparent liner 20 can be applied in any suitable manner, such by coating colorizing surface 18 with a composition for the transparent liner 20 to thereby form a coating of transparent liner 20. This can include a step of drying the silane-free light transmitting colorizing layer 16 prior to applying the transparent liner 20 thereto. Transparent liner 20 can comprise polyethylene terephthalate (PET). Transparent liner 20, which can be referred to as PET liner 20, defines a liner surface 22 which can comprise an adhesive layer (not shown) on which a fabric or a heat transfer film (not shown) can be disposed.

Colorized retroreflective material 10 can be applied to a suitable fabric, garment, or other desired item. Suitable items to which colorized retroreflective material 10 can be applied include sportswear and/or outerwear. Application of colorized retroreflective material 10 can include removing a fabric or a heat transfer film as to expose an adhesive layer. In other embodiments, application of colorized retroreflective material 10 can include sewing colorized retroreflective material 10 to an item (e.g., garment).

The retroreflective material 10, which includes the silane-free light transmitting colorizing layer 16, and which can be a combination of the silane-free light transmitting colorizing layer 16 further coated to the fabric or the heat transfer film, as mentioned above, can provide a reflectivity of more than 150 cd/lux/m². This can be referred to as retroreflective material 10 having an initial reflectivity of more than 150 cd/lux/m². In one or more embodiments, the initial reflectivity is about 330 cd/lux/m². In one or more embodiments, the initial reflectivity is from about 150 cd/lux/m² to about 330 cd/lux/m². The retroreflective material 10 should maintain a reflectivity of more than 100 cd/lux/m², or more than 150 cd/lux/m², throughout the life of the garment on which the retroreflective material is disposed. The retroreflective material 10 can comply with ANSI/ISEA 107-2020 and CSA Z96-15, and reflectivity can be measured according to ASTM E808-01 and ASTM E809-08.

Retroreflective material 12 may therefore be effectively and permanently colorized by the application of silane-free light transmitting colorizing layer 16 to retroreflective material surface 14. Further details regarding compositional aspects of silane-free light transmitting colorizing layer 16 are provided herein below, and the skilled person will understand that the composition of silane-free light transmitting colorizing layer 16 should be such that the integrity of retroreflective material 12 is not disturbed by the coating of such layer.

As mentioned above, silane-free light transmitting colorizing layer 16 may be applied on retroreflective material 12, which may be referred to as silane-free light transmitting colorizing layer 16 being an overlayer or overprint on retroreflective material 12. The retroreflective material 12 can be a variety of suitable retroreflective materials which include retroreflective elements. As shown in FIG. 2, a particularly suitable retroreflective material 12 includes glass beads 12A embedded with a reflective coating 12B applied to the underside of glass beads 12A, which are within an adhesive binder material 12C. Silane-free light transmitting colorizing layer 16 should be sufficiently thin and transparent enough to allow a high percentage of incident light 24 to pass through the retroreflective material 12 surface and reflect back out through the beads 12A as reflected light 26. The combination of silane-free light transmitting colorizing layer 16 applied on retroreflective material 12 should thereby retain a high degree of reflectivity while also providing sufficient color to be aesthetically pleasing. Controlling the thickness of silane-free light transmitting colorizing layer 16 can be important to strike a balance between the amount of colorizing and the retention of high reflectivity. In one or more embodiments, the thickness of silane-free light transmitting colorizing layer 16 is about 0.001 mm, or in other embodiments, less than 0.001 mm. As further discussed below, it has also further been found that wash durability increases significantly if silane-free light transmitting colorizing layer 16 undergoes a heating step.

As mentioned above, the composition of silane-free light transmitting colorizing layer 16 should not disturb the integrity of retroreflective material 12. The composition for silane-free light transmitting colorizing layer 16 can be designed to be adapted to a variety of types of retroreflective materials 12. Exemplary materials for retroreflective materials 12 include tapes, films, and fabrics. As mentioned above, retroreflective materials 12 generally include a layer of generally closely packed, very small, exposed micro reflective elements 12A partially embedded in an adhesive layer 12C. Retroreflective materials 12 can be with or without additional laminate layers. Retroreflective material 12 may include, without limitation, reflective transfer materials such as iron-on patches or cloth-backed materials to be sewn on a garment. Other aspects of reflective materials 12 will be generally known to the skilled person.

Silane-free light transmitting colorizing layer 16 can derive from a fast-drying ink composition. Silane-free light transmitting colorizing layer 16 should be environmentally friendly, which may refer to the composition being free of one or more of formaldehyde, heavy metals, chlorinated phenols, organotin compounds, MAK amines, allergenic dyestuffs, chlorinated carriers, phthalates, and PVC. In one or more embodiments, the silane-free light transmitting colorizing layer 16 has a composition according to the following Table 1.

TABLE 1

| CAS | | |
|---|---|---|
| Component | Chemical Name/Classification | Concentration |
| CAS 1119-40-0 | dimethyl glutarate | 50-<60% |
| CAS not | Pigment percentage depends | 10-<20% |
| applicable | on color (CAS number): | |
| | Black color (1333-86-4), | |
| | Yellow color (5120-83-0 or | |
| | 22094-93-5), Orange color | |
| | (15793-73-4), Pink color | |
| | (980-26-7), Red color | |
| | (2786-76-7 or 51920-12-8), | |
| | Green color (1328-53-6), Blue | |
| | color (147-14-8), Super | |
| | (57455-37-5) | |
| CAS not | Polyurethane resin | 1-<10% |
| applicable | | |
| CAS | Hydroxy modified vinyl | 1-<10% |
| 25086-48-0 | chloride/vinyl acetate polymer | |
| | STOT SE 3: H335 - Warning | |
| CAS Not | Inorganic acid ester | 1-<10% |
| Known | Eye Irrit. 2A: H319 - Warning | |
| CAS 9003-22-9 | Poly(vinyl chloride-co-vinyl | 1-<10% |
| | acetate) | |
| CAS | Hexane, 1,6-diisocyanate, | 1-<10% |
| 208408-04-2 | homopolymer, di-Et malonate | |
| | and N-(1-methylethyl)-2- | |
| | propylamine blocked | |
| | Skin Sens. 1: H317 - Warning | |
| CAS Not | Fatty acid ester 4 | 1-<10% |
| Known | Flam. Liq. 3: H226 - Warning | |
| CAS 687-47-8 | (S)-2-Hydroxypropionic acid | 1-<10% |
| | ethyl ester | |
| | Eye Dam. 1: H318; Flam. | |
| | Liq. 3: H226; STOT SE 3: | |
| | H335 - Warning | |
| CAS 108-65-6 | Propylene glycol methyl ether | 1-<10% |
| | acetate | |
| | Flam. Liq. 3: H226; STOT SE | |
| | 3: H336 - Warning | |
| CAS | Fumed microdispersed silica, | 1-<10% |
| 112945-52-5 | synthetic X-ray amorphous | |
| | silica (SIO2) | |
| CAS 8013-07-8 | Epoxy soybean oil | 0.1-<1% |
| CAS 106-65-0 | dimethyl succinate | 0.1-<1% |
| CAS 627-93-0 | dimethyl adipate | 0.01-<0.1% |
| CAS 105-53-3 | Diethyl malonate | 0.01-<0.1% |
| | Eye Irrit. 2A: H319; Flam. | |
| | Liq. 4: H227; Skin Irrit. 3: | |
| | H316 - Warning | |
| CAS | Methoxy-1-propanol acetate | 0.0015-<0.005% |
| 70657-70-4 | Flam. Liq. 3: H226; Repr. 1B: | |
| | H360; STOT SE 3: H335 - | |
| | Warning | |

In or more embodiments, silane-free light transmitting colorizing layer 16 is substantially devoid of silane. Being substantially devoid of silane may refer to a composition which is not deleteriously flammable. In or more embodiments, silane-free light transmitting colorizing layer 16 is devoid of silane.

Silane-free light transmitting colorizing layer 16 should provide good adhesion and flexibility on suitable substrates (e.g., retroreflective material 12). Silane-free light transmitting colorizing layer 16 should have a wash resistance up to 95° C. Silane-free light transmitting colorizing layer 16 should provide suitable wet and dry rub properties. Silane-free light transmitting colorizing layer 16 should be dry cleanable and should moreover provide excellent scratch and scuff resistances, in addition to excellent cut and fold properties. In one or more embodiments, properties of the silane-free light transmitting colorizing layer 16 may be according to the following Table 2.

TABLE 2
Heat Lamination Condition

| | | |
|---|---|---|
| Temperature | 150-180° | C. |
| Dwell Time | 10-20 | sec |
| Pressure | 30-40 | psi |

Care and Maintenance Instructions

| Recommended | 60° | C. |
|---|---|---|
| Max. washing | | |
| temp. | | |
| Washing cycle | 50 | min. |
| (Home wash) | | |
| Bleach | Yes | |
| Trumble dry | Yes | |
| Iron | Yes | |
| Dry cleaning | Yes | |
| Dry cleaning | 30 | min. |
| cycle | | |

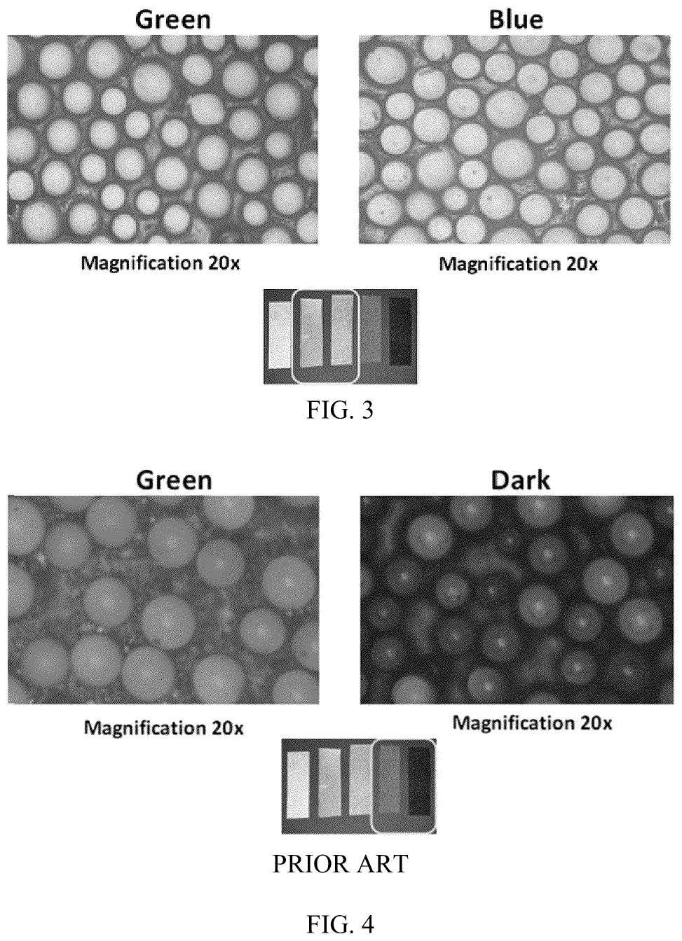

As shown in FIG. 3, exemplary colors which can be provided by the silane-free light transmitting colorizing layer 16 include green and blue. Other colors may be suitable.

While certain advantages of the colorized retroreflective material 10 are included above, other advantages are included here. The colorized retroreflective material 10 overcomes many of the limitations of conventional materials and solves many of the problems associated with conventional materials. The colorized retroreflective material 10 provides a suitable levels of reflectivity and durability that are necessary for use in uniforms, sportswear, outerwear, and other garments worn on a daily basis. Such garments are generally subjected to hard use and can be laundered a total of 50 or more times before being removed from service. The silane-free light transmitting colorizing layer 16 of colorized retroreflective material 10 enables colorized retroreflective material 10 to be colorfast and retain both a high level of reflectivity (e.g., more than 150 cd/lux/m²) and color throughout a large number of laundering cycles (e.g., 50 or more cycles), while also not being flammable, based on the silane-free composition of the ink.

As mentioned above, one or more embodiments relate to a method of manufacturing colorized retroreflective material 10, which may be referred to as a method for colorizing the retroreflective material 12. The method can comprise a step of coating a retroreflective material surface 14 with a silane-free light transmitting colorizing layer 16, which may also be referred to as colored ink 16. The method can further comprise a step of drying the combination of the colorizing retroreflective material 12 coated with the silane-free light transmitting colorizing layer 16 at its retroreflective material surface 14 for a suitable drying time. The method can further comprise a step of coating or laminating a colorizing surface 18, which may be referred to as dried colorizing surface 18, with a transparent liner 20 which comprises polyethylene terephthalate (PET). The method can further comprise a step of removing an excess of the transparent liner 20 (e.g., PET liner 20) from the dried colorizing surface 18 after the step of coating or laminating.

As mentioned above, transparent liner 20 can be a transparent PET liner. Transparent liner 20 should be a liner which is easy to laminate onto dried colorizing surface 18 but also easy to remove from the dried colorizing surface 18, when present in excess after lamination. Such removal of excess should not leave any mark on the dried colorizing surface 18 (or on the retroreflective material surface 14 to the extent of overlap). At the same time, by applying PET transparent liner 20 to silane-free light transmitting colorizing layer 16, adherence of PET transparent liner 20 relative to the reflective material 12 is increased. Therefore, the PET transparent liner 20 provides the following one or more advantages over conventional liners. The transparent feature allows for easy garment placement during heat lamination. PET transparent liner 20 can provide for ease of matching the garment. PET transparent liner 20 can include a removable and reusable pressure sensitive adhesive which can stick to a fabric for easy handling but which can be removed afterwards when the transfer is laminated. In contrast, conventional liners such as a paper liner, are difficult to stick back once removed. And unlike other conventional liners, PET transparent liner 20 can hold onto the other layers and the other layers would not come off easily when the user takes it out from the packaging.

In light of the foregoing, it should be appreciated that the present invention advances the art by providing an improved colorized retroreflective material. While particular aspects of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### Example 1

In a first example, FIG. 4 shows photos of a conventional colorized retroreflective material of the prior art, for comparison with the photos in FIG. 3 which are of a colorized retroreflective material 10 as described above, and manufactured using the method described above. The conventional colorized retroreflective material of FIG. 4, which is made by a different method, provides glass beads having low refractivity index, results in losses of stacks of the beads, and lacks a reflective back layer. These disadvantages are not present in the materials shown in the photos in FIG. 3. The materials shown in the photos in FIG. 3 are advantageous when compared to the conventional materials of FIG. 4.

### Example 2

In a second example, silane-free inks of different colors were used to colorize films and fabrics. Silane-free inks of different colors were used to colorize 3M Scotchlite™ 8725N and 8711 silver retroreflective heat transfer films. A layer of silane-free light transmitting colorizing layer (i.e., the ink) was coated to the retroreflective material surface, that is, to the glass-bead surface. In a similar manner, silane-free inks of different colors were applied to a 3M Scotchlite™ C725 silver retroreflective heat transfer film and further to 3M Scotchlite™ 8910, 8912N, 8925N, 8906, and 9910 silver reflective fabrics. The silane-free inks, for both the heat transfer films (3M Scotchlite™ 8711, 8725N, and C725 retroreflective heat transfer films) and the reflective fabrics (3M Scotchlite™ 8910, 8912N, 8925N, 8906, and 9910), were then dried in an oven at a suitable temperature and time. The colorized retroreflective material obtained was then left at room temperature for about 24 hours, which allowed the retroreflective material to take back its initial/final shape/dimension. Colorfastness tests were performed, which were Martindale tests including 10 rubs in 10 seconds. A transparent PET liner was then coated on the colorized retroreflective material. The length and width of the transparent PET liner was the same as the length and width of the colorized retroreflective material.

Reflectivity and color measurements were then taken. After 50 wash cycles, the appearance of the colorized retroreflective material/tape was similar to before the wash cycles. A reflectivity of more than 150 cd/lux/m², from various observation angles, was reached. Further, good wash durability and color fastness to rubbing were observed. Reflectivity remained high and was close to 95% of the pre-wash reflectivity.

Various modifications and alterations that do not depart from the scope and spirit of this invention will become apparent to those skilled in the art. This invention is not to be duly limited to the illustrative examples set forth herein.

What is claimed is:

1. A colorized retroreflective material comprising
a retroreflective material defining a retroreflective material surface;
a silane-free light transmitting colorizing layer disposed on the retroreflective material surface, the silane-free light transmitting colorizing layer defining a colorizing surface; and
a transparent layer disposed on the colorizing surface;
wherein the colorized retroreflective material provides a reflectivity of more than 150 cd/lux/m².

2. The colorized retroreflective material of claim 1, the transparent layer defining a transparent layer surface, the colorized retroreflective material further comprising an adhesive layer disposed on the transparent layer surface, the adhesive layer defining an adhesive layer surface, the colorized retroreflective material further comprising a fabric layer or a heat transfer layer disposed on the adhesive layer surface.

3. The colorized retroreflective material of claim 2, the transparent layer comprising polyethylene terephthalate.

4. The colorized retroreflective material of claim 3, where the transparent layer derives from a coating step such that the transparent layer is coated on the colorizing surface.

5. The colorized retroreflective material of claim 3, where the transparent layer derives from a lamination step such that the transparent layer is laminated on the colorizing surface.

6. The colorized retroreflective material of claim 1, where the silane-free light transmitting colorizing layer is substantially devoid of silane.

7. The colorized retroreflective material of claim 1, where the silane-free light transmitting colorizing layer is devoid of silane.

8. The colorized retroreflective material of claim 1, where the silane-free light transmitting colorizing layer provides colorization of blue or green to the retroreflective material.

9. The colorized retroreflective material of claim 1, where the colorized retroreflective material maintains the reflectivity of more than 150 cd/lux/m² after 50 wash cycles.

10. A method for colorizing a retroreflective material, the method comprising
providing a retroreflective material suitable for colorizing, the retroreflective material defining a retroreflective material surface;
coating the retroreflective material surface with a silane-free light transmitting colorizing composition;
drying the silane-free light transmitting colorizing composition for a predetermined amount of time, such that the silane-free light transmitting colorizing composition thereby becomes a silane-free light transmitting colorizing layer, the silane-free light transmitting colorizing layer defining a colorizing surface; and
applying a transparent layer on the colorizing surface to thereby provide a colorized retroreflective material;
wherein the colorized retroreflective material provides a reflectivity of more than 150 cd/lux/m².

11. The method of claim 10, the transparent layer defining a transparent layer surface, where an adhesive layer is disposed on the transparent layer surface, the adhesive layer defining an adhesive layer surface, where a fabric layer or a heat transfer layer is disposed on the adhesive layer surface, where the adhesive layer and the fabric layer or the heat transfer layer are applied with the transparent layer during the step of applying the transparent layer.

12. The method of claim 11, the transparent layer comprising polyethylene terephthalate.

13. The method of claim 12, where the step of applying the transparent layer is a coating step.

14. The method of claim 12, where the step of applying the transparent layer is a laminating step.

15. The method of claim 10, where the silane-free light transmitting colorizing composition and the silane-free light transmitting colorizing layer are substantially devoid of silane.

16. The method of claim 10, where the silane-free light transmitting colorizing composition and the silane-free light transmitting colorizing layer are devoid of silane.

17. The method of claim 10, where the silane-free light transmitting colorizing layer provides colorization of blue or green to the retroreflective material.

18. The method of claim 10, where the colorized retroreflective material maintains the reflectivity of more than 150 cd/lux/m² after 50 wash cycles.
